(19) United States
(12) Patent Application Publication
(10) Pub. No.: US 2013/0036229 A1
(43) Pub. Date: Feb. 7, 2013

(54) METHOD OF MANAGING CONNECTION BETWEEN PERSONAL NETWORK AND CPNS SERVICE IN CPNS SYSTEM

(71) Applicant: Seok-Hoon CHOI, Seoul (KR)

(72) Inventor: Seok-Hoon CHOI, Seoul (KR)

(73) Assignee: Samsung Electronics Co., Ltd., Suwon-si (KR)

(21) Appl. No.: 13/566,325

(22) Filed: Aug. 3, 2012

(30) Foreign Application Priority Data
Aug. 5, 2011 (KR) 10-2011-0078357

(51) Int. Cl. G06F 15/16

(52) U.S. Cl. 709/227

(57) ABSTRACT

A method of managing a connection between a Personal Network (PN) and a Converged Personal Network Service (CPNS) server by a first device in a CPNS system including the personal network configured between the first device and a second device including at least one of a Personal Network Entity (PNE) and a Personal Network GateWay (PNGW) and the CPNS server connected with the personal network through a first communication network is provided. The method includes identifying the second device including the PNGW by using device mode information indicating whether the second device included in a PN inventory includes the PNE and the PNGW; requesting a connection between the CPNS server and the second device through the first communication network; and terminating the connection to the CPNS server according to the connection between the CPNS server and the second device through the first communication network.

### PRIORITY

This application claims priority under 35 U.S.C. §119(a) to an application filed in the Korean Industrial Property Office on Aug. 5, 2011 and assigned Serial No. 10-2011-0078357, the entire contents of which are incorporated herein by reference.

### BACKGROUND OF THE INVENTION

1. Field of the Invention

The present invention relates generally to a personal network, and more particularly to a method and an apparatus for providing a service using a personal network.

2. Description of the Related Art

Along with an increase in usage of Consumer Electronics (CEs) having Near Field Communication (NFC) functionality, for example, Motion Picture Experts' Group (MPEG) Audio Layer-3 (MP3) players, Portable Multimedia Players (PMPs), game machines, netbooks, etc., users seek new methods for conveniently downloading content.

In current methods for downloading content, a user generally searches for a reproducible content in consumer electronics through the Internet by using a Personal Computer (PC), and then downloads the searched content. Next, when the consumer electronics and the PC are connected to each other through a dedicated cable, the consumer electronics can download the content from the PC. Through this process, the consumer electronics can reproduce the corresponding content. As an alternative to current methods, the cable may be replaced with a Bluetooth connection, and accordingly, the content can be shared between devices by using a Bluetooth communication scheme.

However, methods by which consumer electronics can directly access a long distance communication network are still highly limited. For example, some consumer electronics can only access a long distance communication network only when such a device is able to access the Internet through a Wireless-Fidelity (Wi-Fi) connection in an area where there is an Access Point (AP). Accordingly, there is a need for a method by which devices that support near field communication but cannot directly access the long distance communication network (i.e., certain consumer electronics) can access the long distance communication network through a gateway to download content, such as a desired service. In response to this need, a Converged Personal Network Service (CPNS) has been proposed.

The CPNS refers to a service for providing a corresponding service or a content after one Personal Network (PN) configured by a combination of a device, which acts as a gateway in charge of communication with a long distance communication network, and consumer electronics, which reproduce an actual service and content, is constructed and the consumer electronics access a service/content providing server located in the long distance communication network through the device acting as the gateway. In such a CPNS, the device acting as the gateway is referred to as a Personal Network (PN) gateway and the consumer electronics accessing the long distance communication network through the PN gateway are referred to as a Personal Network Entity (PNE).

Types of services provided through a PN include, for example, various types of software services for upgrading respective consumer electronics, a dynamic image content service, an image content service, an audio content service, a game service, etc. Among such services, there is also a service for grouping a plurality of participants to one group and providing contents in the unit of groups. For example, when using a game service providing a board game, a service group including a plurality of participants who participate in the board game is configured. Then, the game service is provided in units of service groups, so that the participants of the service group can play the board game together. A service provider providing the service in units of groups must have functions for generating and managing the service group.

Accordingly, each service provider providing the service in units of groups directly generates and manages the service group. For example, a service/content providing server for providing the board game service must provide a related application installed in a user terminal so as to provide the game service. Further, when the user terminal makes a request for providing the service through the application, the service/content providing server generates a service group by grouping other user terminals to play the board game with the user terminal, and transmits proper data according to the board game performance to the user terminals included in the generated service group. As a result, the board game service is provided.

### SUMMARY OF THE INVENTION

Accordingly, an aspect of the present invention is to solve the above-mentioned problems occurring in the prior art, and to provide a method capable of switching a gateway accessing a CPNS service while maintaining an already connected personal network.

In accordance with an aspect of the present invention, a method of managing a connection between a Personal Network (PN) and a Converged Personal Network Service (CPNS) server by a first device in a CPNS system including the personal network configured between the first device and a second device including at least one of a Personal Network Entity (PNE) and a Personal Network Gateway (PNGW) and the CPNS server connected with the personal network through a first communication network is provided. The method includes identifying the second device including the PNGW by using device mode information indicating whether the second device included in a PN inventory includes the PNE and the PNGW; requesting a connection between the CPNS server and the second device through the first communication network; and terminating the connection to the CPNS server connected through the first communication network according to the connection between the CPNS server and the second device through the first communication network.

In accordance with another aspect of the present invention, a method of managing a connection between a personal network and a CPNS server by a second device in a CPNS system including the personal network configured between a first device and the second device including at least one of a PNE and a PNGW and the CPNS server connected with the personal network through a first communication network is provided. The method includes receiving a request to connect to the CPNS server, which is issued from the first device connected to the CPNS server through the first communication network, through the first communication network, by the second device including the PNGW; identifying whether the connection to the CPNS server through the first communication network is available; providing the first device with information indicating whether the connection to the CPNS server through the first communication network is available; and notifying a third device that the second device has connected to the CPNS server through the first communication network according to an availability of the connection to the CPNS server through the first communication network.

In accordance with another aspect of the present invention, a method of managing a connection between a personal network and a CPNS server by the CPNS server in a CPNS system including the personal network configured between a first device and a second device including at least one of a PNE and a PNGW and the CPNS server connected with the personal network through a first communication network is provided. The method includes receiving a request for switching the connection through the first communication network from the first device connected through the first communication network to the second device including the PNGW; identifying whether the second device is available to be connected through the first communication network; requesting, by the second device, a connection through the first communication network; and providing the first device connected through the first communication network with information indicating an availability of the connection of a second device through the first communication network according to the identified availability of the connection of the second device.

### BRIEF DESCRIPTION OF THE DRAWINGS

The above and other aspects, features and advantages of the present invention will become more apparent by the following detailed description of certain embodiments of the invention, taken with the accompanying drawings, in which:

FIG. 1 is a diagram illustrating a configuration of a CPNS system according to an embodiment of the present invention;

FIG. 2 is a block diagram illustrating a configuration of a PNE to which a method of managing a connection with a CPNS server is applied according to an embodiment of the present invention;

FIG. 3 is a block diagram illustrating a detailed configuration of a PN connection controller of FIG. 2;

FIG. 4 is a block diagram illustrating a configuration of a PNGW to which a method of managing a connection with a CPNS server is applied according to an embodiment of the present invention;

FIG. 5 is a diagram illustrating a configuration of a CPNS server to which a method of managing a connection with a CPNS server is applied according to an embodiment of the present invention;

FIG. 6 is a diagram illustrating a detailed configuration of a controller of FIG. 5;

FIG. 7 is a signal flowchart illustrating a method of managing a connection with a CPNS server according to a first embodiment of the present invention;

FIG. 8 is a signal flowchart illustrating a method of managing a connection with a CPNS server according to a second embodiment of the present invention;

FIG. 9 is a signal flowchart illustrating a method of managing a connection with a CPNS server according to a third embodiment of the present invention;

FIG. 10 is a flowchart illustrating operations of a PNGW included in a device making a request for switching a gateway according to an embodiment of the present invention;

FIG. 11 is a flowchart illustrating operations of a PNE included in a device subject to switching of a gateway in a method of managing a connection with a CPNS server according to an embodiment of the present invention;

FIG. 12 is a flowchart illustrating operations of a PNGW included in a device subject to switching of a gateway in a method of managing a connection with a CPNS server according to an embodiment of the present invention; and

FIG. 13 is a flowchart illustrating operations of a CPNS server in a method of managing a connection with a CPNS server according to an embodiment of the present invention.

### DETAILED DESCRIPTION OF EMBODIMENTS OF THE PRESENT INVENTION

Embodiments of the present invention are described as follows with reference to the accompanying drawings. In the following description, the same elements shown in different drawings may be designated by the same or similar reference numerals. Further, in the following description of the present invention, a detailed description of known functions and configurations incorporated herein may be omitted such a description may obscure the subject matter of the present invention.

For convenience of the description of the present invention, names of entities defined in a Converged Personal Network Service (CPNS) of an Open Mobile Alliance (OMA), which is an application standard organization of a mobile terminal are used, but such standards and names do not limit the scope of the present invention, and embodiments of the present invention may be applied to other similar communications systems.

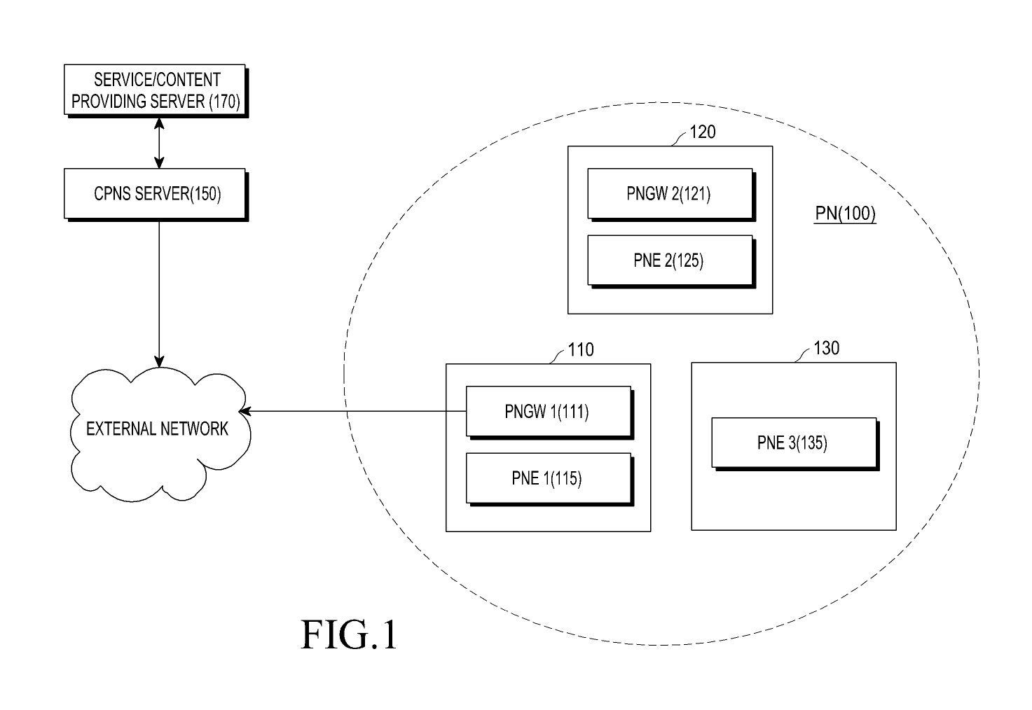

FIG. 1 is a diagram illustrating a configuration of a CPNS system according to an embodiment of the present invention.

The CPNS is an example of a service providing a corresponding service or content after one Personal Network (PN), which includes a combination of a device serving as a gateway in charge of communication with a long-distance communication network and consumer electronics reproducing the actual service, and content is configured and the consumer electronics access a service/content providing server located in the long-distance communication network through the device serving as the gateway.

In such a CPNS, the devices included in the personal network are referred to as network devices. From among the network devices, the electronic device serving as the gateway among the network devices is referred to as a Personal Network (PN) gateway. Meanwhile, consumer electronics connected to the personal network gateway through near field communication and accessing the long-distance communication network through the personal network gateway are referred to as Personal Network Entities (hereinafter, referred to as a “PNEs”). Further, the PN gateway, the PNE, and the personal network are registered and managed, and then a service or content provided by the service/content providing server is transferred to a corresponding PN gateway (or personal network). Furthermore, according to embodiments of the present invention, the network device may include the PNE or the PNGW, and the network device including the PNE or the PNGW may be either of a device that selectively includes one of the PNE and the PNGW, or a device that includes both the PNE and the PNGW. For example, according to an embodiment of the present invention, a first device 110 includes a first personal network gateway 111 and a first personal network entity 115, a second device 120 includes a second personal network gateway 121 and a second personal network entity 125, and a third device 130 includes a third personal network entity 135.

The PNEs 115, 125, and 135 are user terminal devices for directly executing a service. For example, the PNE corresponds to device such as an MP3 player, a PMP, a mobile communication terminal, etc. Such devices provide the service to a user through a reproduction of a content stored in the device. The PNEs 115, 125, and 135 each have a respective near field communication module therein so as to perform near field communication with another device near the PNEs, (i.e., a device including another PNE or PNGW).

The PNEs 115, 125, and 135 configure a personal network 100 by performing a physical pairing with a neighbor device through near field communication. Herein, configuration of the personal network refers to an identification of a role of each physically paired device and configuration of a network between the PNEs or the PNGWs included in the devices in order to provide a CPNS. For the configuration, a determination is performed as to whether the CPNS is supported by the PNEs or the PNGW included in the devices, as well as whether the CPNS is available through an authentication and an authorization, and a device's role is identified (i.e., whether the device is operated as the PNE or the PNGW), so that a network is formed in an aspect of an application for providing the CPNS. Through the personal network 100 configured as described above, the PNE 115, 125, or 135 can access the CPNS server 150 by using a communication function of the PNGW 111 or 121 capable of accessing an external network.

The PNGWs 111 and 121 are devices capable of accessing the CPNS server 150 located in an external network (i.e., the service provider network). Further, the PNGWs 111 and 121 configure the personal network with the PNEs 115, 125, and 135, and relay CPNS system message transmission and service or content transmission between the CPNS server 150 and the PNEs 115, 125, and 135. When the PNE 115, 125, or 135 included in the personal network 100 requests a service, the PNGW 111 or the PNGW 121 relays the service transmission to the CPNS server 150. Further, the PNGW 111 or the PNGW 121 performs a function of transferring a service or a content provided by the CPNS server 150 to the PNE 115, 125, or 135. The PNGWs 111 and 121 may be, for example, a mobile phone, a PDA, a set top box, etc.

The CPNS server 150 is a server device for registering and managing information on the personal network 100 containing information on the PNGW 111 or 121 and the PNE 115, 125, or 135 according to a registration request from the PNGW 111 or 121, or the PNE 115, 125, or 135, and processing a service or content request transmitted by the PNE 115, 125, or 135 through the PNGW 111 or 121. When the service or the content corresponding to the request can be provided by the CPNS server 150, the CPNS server 150 provides the requested service and content to the PNE 115, 125, or 135 through the PNGW 111 or 121. Further, when the service or the content corresponding to the request cannot be provided by the CPNS server 150, the request is transferred to the external service/content providing server 170 and the corresponding service or content is provided to the PNE 115, 125, or 135 through the PNGW 111 or 121.

The service/content providing server 170 exists in the external network, and supplies a service or content for a user in the CPNS server 150. The external network may be, for example, an Internet, a mobile phone operating network, such as an SK Telecom service network or other such network.

Meanwhile, in the CPNS system configured as described above, a plurality of devices may be arranged within the personal network 100. Among the plurality of devices including the PNGW, one PNGW designated during a process of configuring the personal network 100 accesses the CPNS server 150, and the personal network 100 is managed by the device including the designated PNGW. In general, the PNGW of other devices that are not designated as the designated PNGW during the process of configuring the personal network 100 are configured to remain in a state where its operation is deactivated.

Further, a method of managing a connection with the CPNS server according to an embodiment of the present invention switching the PNGW of the device having accessed the CPNS server 150 (for example, the PNGW 111 of the first device 110) to the PNGW of another device (for example, the PNGW 121 of the second device 120) while continuously maintaining the already configured personal network 100.

Hereinafter, configurations of the PNE, the PNGW, and the CPNS to which the method of managing the connection with the CPNS server according to an embodiment of the present invention is applied are described.

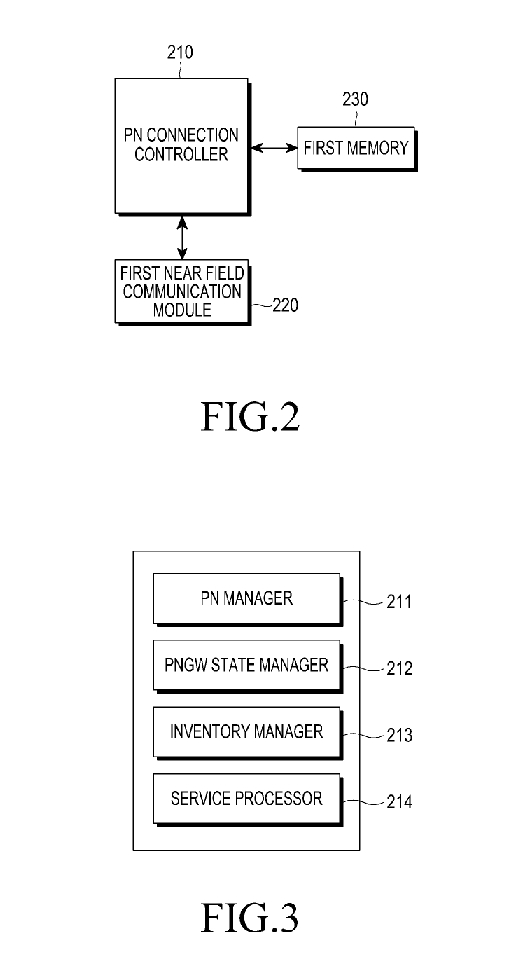

FIG. 2 is a block diagram illustrating a configuration of a PNE to which a method of managing a connection with a CPNS server is applied according to an embodiment of the present invention.

Referring to FIG. 2, a PNE includes a PN connection controller 210, a first near field communication module 220, and a first memory 230.

The first near field communication module 220 is a module for performing near field communication, and may be, for example, a module for performing Bluetooth communication, Zigbee communication, Infrared Data Association (IrDA) communication, visible light communication, Universal Plug & Play (UPnP) communication, Wi-Fi communication, etc.

The first memory 230 may be used as a working memory of the PN connection controller 210. The first memory 230 stores various program data required for configuring the personal network, and stores device information on the PNE. The first memory 230 also stores a service document included in a service guide message transmitted from the CPNS server through the PNGW. The service document contains a list of various types of services, an identifier of each service, information on an application required for executing each service, information on a brief description of each service and the like. The first memory 230 also stores information related to various types of service applications installed in the PNE.

FIG. 3 is a block diagram illustrating a detailed configuration of the PN connection controller 210 of FIG. 2. Referring to FIG. 3, the PN connection controller 210 includes a PN manager 211, a PNGW state manager 212, an inventory manager 213, and a service processor 214.

The PN manager 211 controls all operations of the PNE related to a personal network configuration and a personal network release, and controls an operation related to a service request and service reception or a content request and content reception through the configured personal network. Accordingly, the PN manager 211 controls the first near field communication module 220 to configure the personal network, and performs a physical pairing with neighbor devices to configure a communication link. Further, the PN manager 211 performs a search for the PNGW among the physically paired devices, and makes a request for a personal network connection when the PNGW is found.

The PNGW state manager 212 performs a PNGW switching operation within the personal network in response to reception of the request for switching the PNGW of the device having already accessed the CPNS server (e.g., the PNGW 111 of the first device 110 of FIG. 1) to another PNGW (e.g., the PNGW 121 of the second device 120 of FIG. 1). The PNGW state manager 212 receives the gateway switching request message from the PNGW of the device having already accessed the CPNS server, identifies identification information of the PNGW included in the same device of the PNE among information contained in the gateway switching request message, and identifies an operation state of the PNGW corresponding to the identification information. The operation state may contain information indicating an active/inactive state of the PNGW included in the same device of the PNE. Further, when the PNGW is in the inactive state, the PNGW state manager 212 controls activation of the PNGW to switch between PNGWs within the personal network.

Furthermore, when the PNGW is in the inactive state, the PNGW state manager 212 may further contain information indicating whether the PNGW is deactivated by a basic setting of the device (for example, a case where the PNGW is deactivated because a residual quantity of a battery is less than or equal to a predetermined value) or the PNGW is intentionally deactivated by a user's setting. The PNGW state manager 212 can control the activation/inactivation of the PNGW in consideration of such factors. For example, when the PNGW is deactivated by the basic setting of the device, the PNGW state manager 212 controls such that the PNGW is activated. When the PNGW is intentionally deactivated by the user's setting, the PNGW state manager 212 controls such that the inactive state of the PNGW is maintained, and notifies that the PNGW cannot be switched within the personal network.

The inventory manager 213 continuously renews an inventory value of the personal network, which is shared during the process of configuring the personal network or changed in the personal network, and stores the inventory value in the first memory 230. For example, the inventory value may contain identification information of the personal network, identification information of the device included in the personal network, identification information of the PNGW or the PNE included in the device included in the personal network, mode information of the device included in the personal network and the like.

The service processor 214 stores the service document contained in the service guide message transmitted from the CPNS server through the PNGW in the first memory 230. The service processor 214 also configures a particular service providing request message according to a user's request to transmit the configured message to the CPNS server through the PNGW, and performs operations corresponding to various types of service applications installed in the PNE.

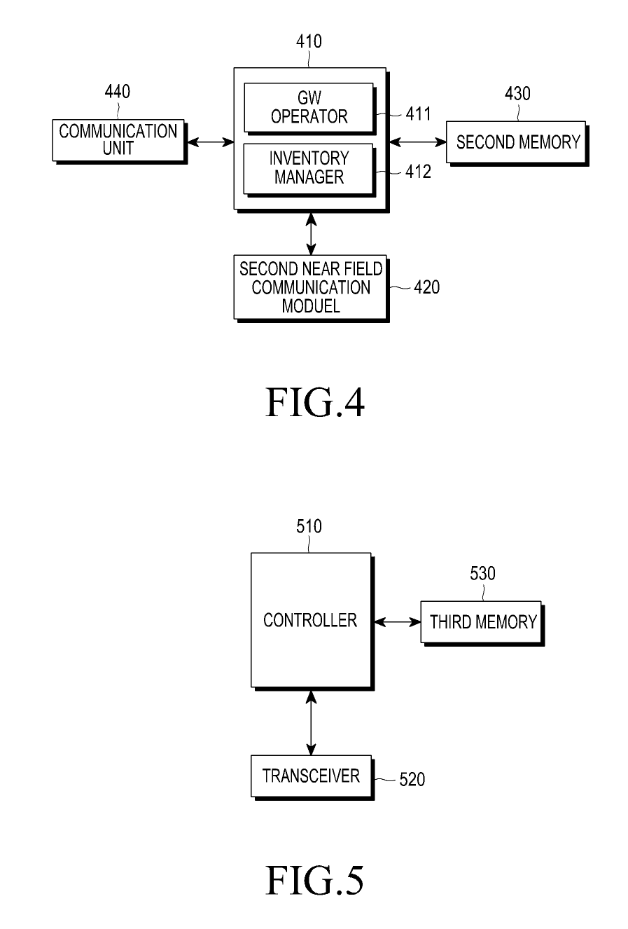

FIG. 4 is a block diagram illustrating a configuration of the PNGW to which the method of managing the connection with the CPNS server is applied according to an embodiment of the present invention.

Referring to FIG. 4, a PNGW according to an embodiment of the present invention includes a PN manager 410, a second near field communication module 420, a second memory 430, and a communication unit 440.

The second communication module 420 performs near field communication, and may be, for example, a module for performing Bluetooth communication, Zigbee communication, IrDA, visible light communication, UPnP communication, Wi-Fi communication, etc.

The communication unit 440 communicates with entities of the external network, and transmits/receives data to/from the CPNS server and the service/content providing server.

The second memory 430 may be used as a working memory of the PN manager 410, and stores various types of program data required for configuring the personal network. The second memory 430 also stores inventory information, such as identification information of the personal network connected to the personal network, identification information of the device included in the personal network, identification information of the PNGW or the PNE included in the device included in the personal network, mode information of the device included in the personal network and the like.

The PN manager 410 controls a general operation of the PNGW related to the personal network, and includes a GW operator 411 and an inventory manager 412. The GW operator 411 controls the second near field communication module 420 to configure the personal network, and performs a physical pairing with neighbor devices to configure a communication link. When the GW operator 411 receives a mode search message from the physically paired device, the GW operator 411 transmits a response message indicating that the device is the PNGW to the corresponding device. When the GW operator 411 receives a personal network connection request from the paired device, the GW operator 411 authenticates and authorizes the corresponding device.

The GW operator 411 requests for switching the gateway to the PNGW of another device within the personal network, or processes the gateway switching requested by another device.

When gateway switching to the PNGW of another device within the personal network is requested, the GW operator 411 identifies the device mode information indicating whether the device included in the personal network includes the PNE or the PNGW from the PN inventory stored in the second memory 430, and searches for the PNGW included in another device within the personal network. Next, the GW operator 411 selects a PNGW that becomes a target of the gateway switching within the personal network from the found PNGWs included in another device. After selecting the PNGW, the GW operator 411 generates the gateway switching request message requesting the gateway switching within the personal network, identifies the identification information of the PNE included in the same device of the selected PNGW, and transmits the gateway switching request message to the PNE included in the same device of the PNGW. The gateway switching request message may contain identification information of the personal network, identification information of the PNGW included in the device requesting the gateway switching, identification information of the PNGW included in the target of the gateway switching, and expected state information of the PNGW included in the device requesting the gateway switching (i.e., mode information of the device to be set after a gateway function is delegated to another PNGW). This information may be represented as shown in Table 1 below.

TABLE 1

| | | | Data | |
|---|---|---|---|---|
| Element | Cardinality | T | Type | Description |
| PNGW | 1 | E | | Its sub element is |
| Switching | | | | PNInfo |
| Request | | | | |
| PNInfo | 1 | E | | Refers to changes in personal |
| | | | | network information to be |
| | | | | updated. |
| | | | | Its sub attributes are |
| | | | | PNID |
| | | | | Update |
| | | | | Its sub element is |
| | | | | PNGWInfo |
| PNID | 1 | A | String | PN Identifier |
| PNGWInfo | 1 | E | | Refers to information on the |
| | | | | PNGW to perform a function |
| | | | | as the gateway, and is |
| | | | | designated by the PNGW |
| | | | | (first PNGW in this |
| | | | | specification) to |
| | | | | as the gateway. |
| PNGWID | 0 . . . 1 | A | String | Refers to a PNGW identifier |
| | | | | (second PNGW in this |
| | | | | specification) to function as |
| | | | | the gateway. |
| Name | 0 . . . 1 | A | String | Refers to a name of the |
| | | | | PNGW to function |
| | | | | as the gateway. |
| Update | 1 | A | Integer | Refers to a changed |
| | | | | information (update |
| | | | | information) state of the |
| | | | | terminal requesting a |
| | | | | delegation. |
| | | | | 0: Current, remains in a |
| | | | | personal network |
| | | | | configuration member |
| | | | | as the PNGW after the |
| | | | | delegation of authority |
| | | | | 1: Update, remains in a |
| | | | | personal network |
| | | | | configuration member |
| | | | | as the PNE after the |
| | | | | delegation of authority |
| | | | | 2: Removed, the PNE and the |
| | | | | PNGW withdraw from the |
| | | | | personal network (PN) after |
| | | | | the delegation of authority |

The GW operator 411 receives state information indicating whether the PNGW included in the device to be a target of the gateway switching can operate as the gateway and an authorization result of the CPNS for the operation as the gateway. The state information and the authorization result may be received from the device intended to be the target of the gateway switching. Alternatively, the state information may be received from the device intended to be the target of the gateway switching, and the authorization result of the CPNS may be separately received form the CPNS server.

The GW operator 411 can reset the mode of the device through communication with the PNE as the function of the gateway is delegated to the PNGW included in another device.

Although, with respect to the above-described embodiment of the present invention, the GW operator 411 selects the PNGW that is the target to be switched to the gateway within the personal network and transmits the gateway switching request message to the PNE included in the same device of the selected PNGW, embodiments of the present invention are not limited thereto. For example, the GW operator 411 can transmit the gateway switching request message to all PNEs included in the same device of the PNGW included in the found another device. Further, the GW operator 411 may transmit the gateway switching request message to the CPNS server without transmitting the gateway switching request message to the PNE included in the same device of the selected PNGW. Furthermore, alternatively, the GW operator 411 may transmit a gateway switching request message containing only information for requesting the gateway switching to the CPNS server without information corresponding to the device intended to be the target of the gateway switching, and without performing the search for the PNGW included in another device within the personal network.

Meanwhile, after the GW operator 411 processes gateway switching requested by another device, the GW operator 411 receives the gateway switching request message from the PNE and transmits a PN update request message to the CPNS server as a message for requesting an authorization for the operation as the gateway. Here, the gateway switching request message and the PN update request message may contain identification information of the personal network, identification information of the PNGW included in the device intended to be the target of the gateway switching, and expected state information of the PNGW included in the device requesting the gateway switching (i.e., mode information of the device to be set after the gateway function is delegated to another PNGW). For example, the PN update request message may include information represented in Table 2.

TABLE 2

| | | | Data | |
|---|---|---|---|---|
| Element | Cardinality | T | Type | Description |
| PNUpdate- | 1 | E | | Its sub element is |
| Request | | | | PNInfo |
| PNInfo | 1 | E | | Refers to information of the |
| | | | | PN to be updated. |
| | | | | Its sub attributes are |
| | | | | PNID |
| | | | | Update |
| | | | | Its sub element is |
| | | | | PNGWInfo |
| PNID | 1 | A | String | Refers to a PN Identifier to |
| | | | | be updated. |
| PNGWInfo | 1 | E | | Refers to information on the |
| | | | | PNGW to function as the |
| | | | | gateway, and is designated |
| | | | | by the PNGW (first PNGW |
| | | | | in this specification) to |
| | | | | function as the gateway. |
| PNGWID | 1 | A | String | Refers to a PNGW identifier |
| | | | | (second PNGW in this |
| | | | | specification) to function as |
| | | | | the gateway. |
| Name | 0 . . . 1 | A | String | Refers to a name of the |
| | | | | PNGW to function as the |
| | | | | gateway |
| Update | 1 | A | Integer | Refers to changed |
| | | | | information of the terminal |
| | | | | requesting a delegation. |
| | | | | 0: Current, remains in a |
| | | | | personal network |
| | | | | configuration member as the |
| | | | | PNGW after the delegation |
| | | | | of authority |
| | | | | 1: Update, remains in a |
| | | | | personal network |
| | | | | configuration member as the |
| | | | | PNE after the delegation of |
| | | | | authority |
| | | | | 2: Removed, the PNE and |
| | | | | the PNGW withdraw from |
| | | | | the personal network (PN) |
| | | | | after the delegation of |
| | | | | authority |

The GW operator 411 receives a PN update response message containing an authorization result for the operation as the gateway, and can transmit the authorization result and a gateway switching response message containing an operation state of the PNGW to the PNGW included in the device requesting the gateway switching. Alternatively, the GW operator 411 receives the PN update response message containing the authorization result for the operation as the gateway from the CPNS server, and then can transmit the gateway switching response message containing only the operation state of the PNGW to the PNGW included in the device requesting the gateway switching In this case, the GW operator 411 operates such that when the gateway switching to the PNGW of another device is requested, the GW operator 411 can receive the authorization result for the operation as the gateway is provided from the CPNS through a PN update notification message.

For example, the PN update response message may include information as represented in Table 3, and the gateway switching response message may include information as represented in Table 4.

TABLE 3

| | | | Data | |
|---|---|---|---|---|
| Element | Cardinality | T | Type | Description |
| PNUpdate- | 1 | E | | Its sub attributes are |
| Response | | | | Result |
| Result | 1 | A | Integer | Refers to a processing result |
| | | | | of requested matters in the |
| | | | | CPNS server. |
| | | | | 1: Success |
| | | | | 2: Fail, refers to the PN that |
| | | | | has not been registered |
| | | | | before. |
| | | | | 3: Fail, refers to the PNE |
| | | | | that is not a personal |
| | | | | network (PN) member |

TABLE 4

| Element | Cardinality | T | Data Type | Description |
|---|---|---|---|---|
| PNGW | 1 | E | | Its sub attributes are |
| Switching | | | | Status |
| Response | | | | Result |
| Status | | | | Presents a success or fail as |
| | | | | a processing result of the |
| | | | | gateway to receive a |
| | | | | delegation of authority for |
| | | | | an authority delegation |
| | | | | request. When a value of |
| | | | | the response message is |
| | | | | failure, personal network |
| | | | | information below except |
| | | | | for a corresponding element |
| | | | | may not be included. |
| | | | | 1: Success |
| | | | | 2: Fail, reject the delegation |
| | | | | of a role of the GW. |
| | | | | 3: Fail, there is no pre- |
| | | | | registered personal network. |
| Result | 1 | A | Integer | Refers to a processing result |
| | | | | of requested matters in the |
| | | | | CPNS server. |
| | | | | 1: Success |
| | | | | 2: Fail, refers to the PN that |
| | | | | has not been registered |
| | | | | before. |
| | | | | 3: Fail, refers to the PNE |
| | | | | which is not a personal |
| | | | | network member |

Meanwhile, the inventory manager 412 continuously renews an inventory value of the personal network that is shared during the process of configuring the personal network or changed in the personal network and stores the inventory value in the first memory 430.

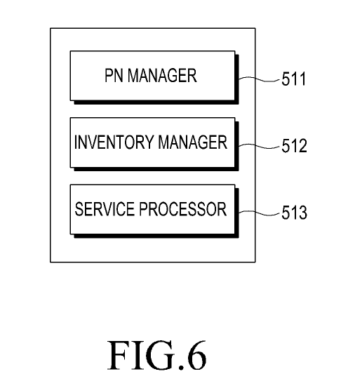

FIG. 5 is a diagram illustrating a configuration of the CPNS server to which the method of managing the connection with the CPNS server is applied according to an embodiment of the present invention. FIG. 6 is a diagram illustrating a detailed configuration of the controller of FIG. 5.

Referring to FIGS. 5 and 6, the CPNS server includes a controller 510, a transceiver 520, and a third memory 530.

The transceiver 520 communicates with the PNGW and the service/content providing server according to a control of the controller 510.

The third memory 530 stores inventory information, such as identification information of the personal network connected to the personal network, identification information of the device included in the personal network, identification information of the PNGW or the PNE included in the device included in the personal network, mode information of the device included in the personal network, etc. The third memory 530 also stores various types of contents, services, etc. to be provided to the PNE, and stores a service matching table corresponding to each content and service. The service matching table includes information corresponding to a minimum device function and capability required of the PNE to receive and process a corresponding content or service.

The third memory 530 also stores service information provided from the service/content providing server according to an embodiment of the present invention. The service information contains a list of various types of the services provided from the service/content providing server, each service identifier, information on an application required for executing each service, information on a brief description of each service and the like. The third memory 530 also stores applications corresponding to various types of services.

The controller 510, which controls general operations of the CPNS server, includes a PN manager 511, an inventory manager 512, and a service processor 513. The PN manager 511 performs a CPNS utilization authentication and authorization for the PNE included in a PNE list according to a PNE list registration request of the PNGW. The inventory manager 512 also stores a result of the CPNS utilization authentication and authorization for the PNE included in the PNE list in a third memory 540.

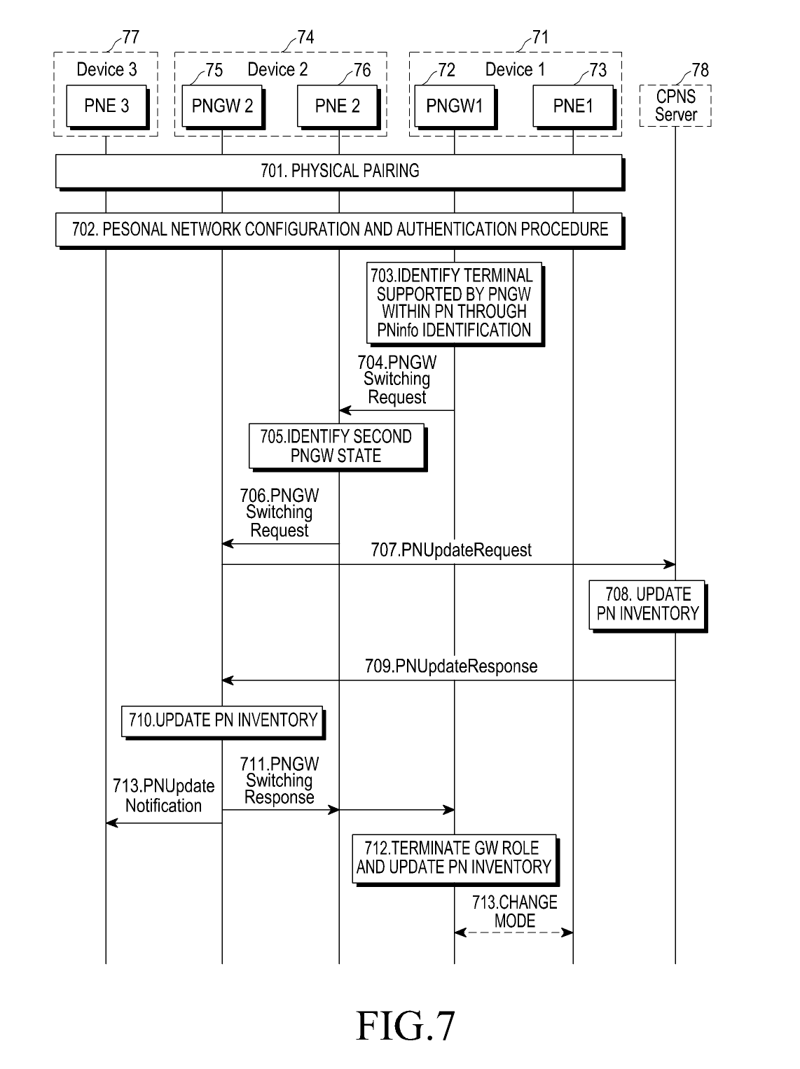

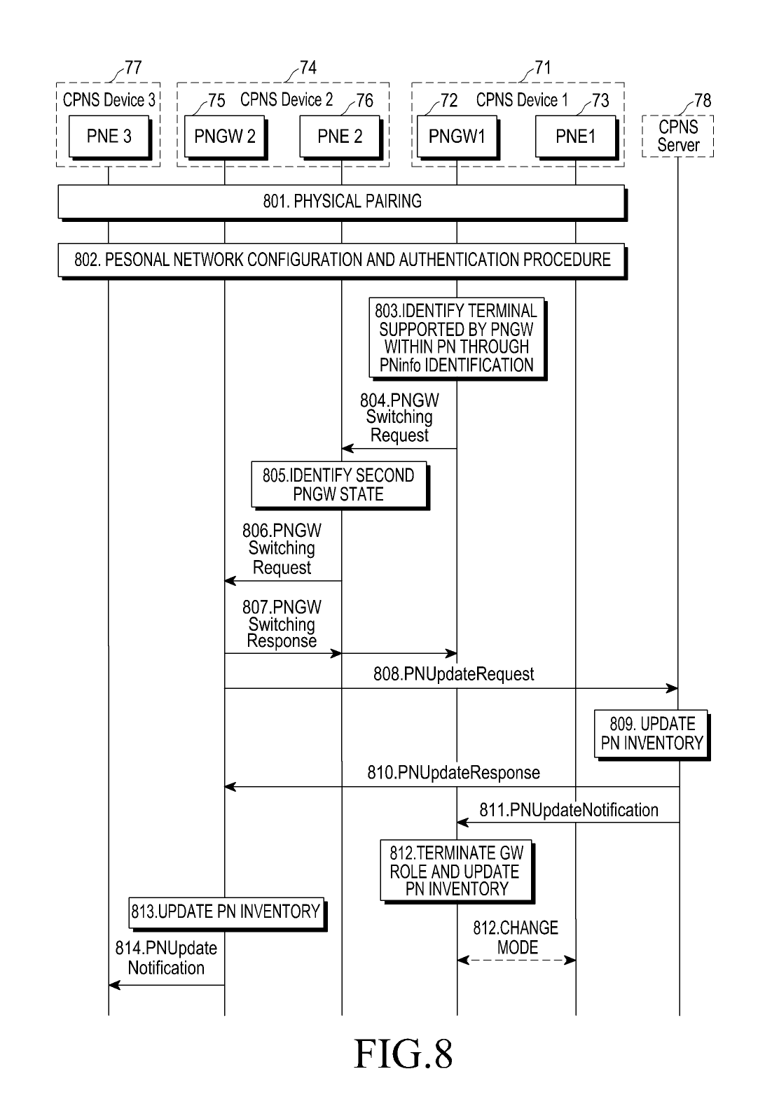

When the PN manager 511 implements a method of managing the connection with the CPNS server (see description corresponding to FIGS. 7 and 8 below) according to first and second embodiments of the present invention, the PN manager 511 simply receives the PN update request message (see Table 3) from the device intended to be the target of the gateway switching and processes an authorization indicating whether the device intended to be the target of the gateway switching can function as the gateway. The PN manager 511 may transmit the PN update response message (see Table 4) containing an authorization result to the device intended to be the target of the gateway switching, or additionally transmit the PN update notification message to the device having requested the gateway switching.

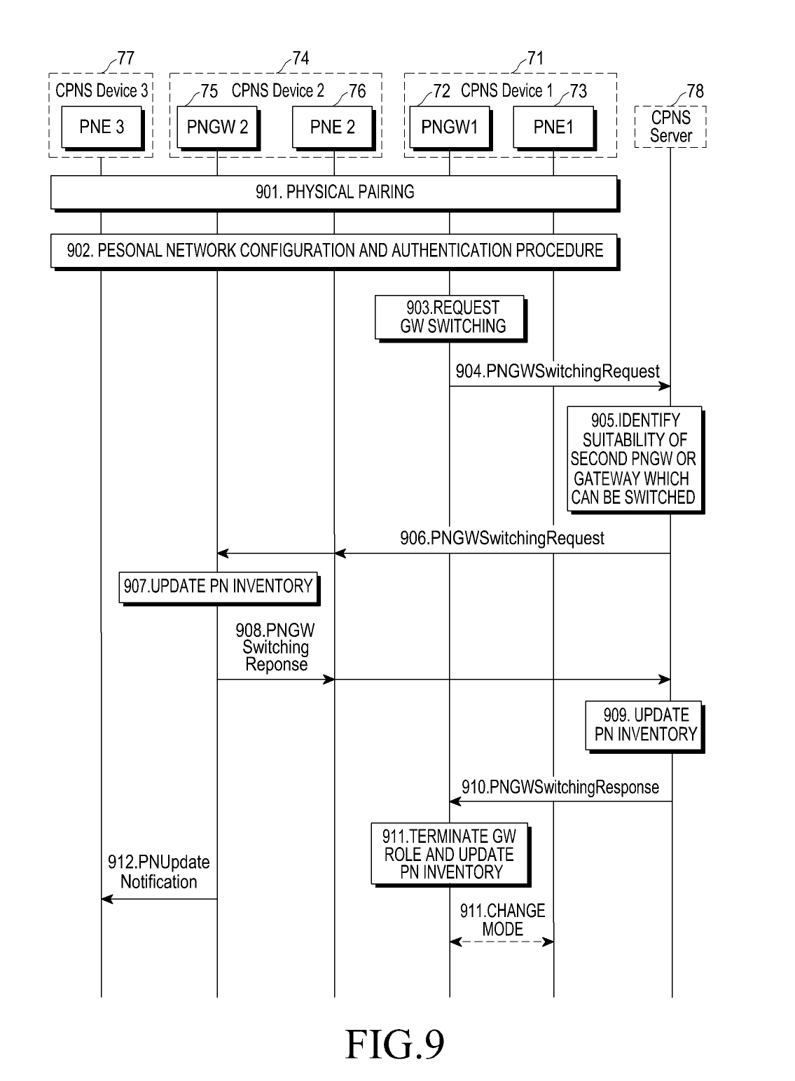

Meanwhile, when the PN manager 511 implements the method of managing the connection with the CPNS server (see description corresponding to FIG. 9 below) according to a third embodiment of the present invention, the PN manager 511 can perform a PNGW switching operation within the personal network in response to reception of the request for switching the PNGW of the already accessed device (for example, the PNGW 111 of the first device 110, see FIG. 1) to another PNGW (for example, the PNGW 121 of the second device 120, see FIG. 1). For example, the PN manager 511 receives the gateway switching request message from the PNGW of the already accessed device. Here, the gateway switching request message may contain identification information of the personal network, identification information of the PNGW included in the device requesting the gateway switching, information indicating whether identification information of the PNGW included in the device intended to be the target of the gateway switching is included in the gateway switching request message, identification information of the PNGW included in the device intended to be the target of the gateway switching, expected state information of the PNGW included in the device requesting the gateway switching (i.e., mode information of the device to be set after the gateway function is delegated to another PNGW), etc.

When the identification information of the PNGW included in the device intended to be the target of the gateway switching is included in the gateway switching request message, the PN manager 511 identifies identification information of the PNGW included in the device intended to be the target of the gateway switching and the PNE included in the device based on the mode information of the device stored in the inventory. The PN manager 511 also processes the authorization indicating whether the device intended to be the target of the gateway switching can function as the gateway.

Meanwhile, when the identification information of the PNGW included in the device intended to be the target of the gateway switching is not included in the gateway switching request message, the PN manager 511 searches for the device in which the PNGW is activated within the personal network and selects the device including the PNGW to be switched as the gateway based on the mode information of the device stored in the inventory. In selecting the device including the PNGW to be switched as the gateway, the PN manager 511 processes the authorization indicating whether the device in which the PNGW is activated can function as the gateway, in order to select the device including the PNGW to be switched as the gateway.

For example, the gateway switching request message may include information represented in Table 5 below.

TABLE 5

| | | | Data | |
|---|---|---|---|---|
| Element | Cardinality | T | Type | Description |
| PNGW | 1 | E | | Its sub element is |
| Switching | | | | PNInfo |
| Request | | | | |
| PNInfo | 1 | E | | Refers to changes in personal |
| | | | | network information to be |
| | | | | updated. |
| | | | | Its sub attributes are |
| | | | | PNID |
| | | | | Update |
| | | | | Its sub element is |
| | | | | PNGWInfo |
| PNID | 1 | A | String | PN Identifier |
| PNGWInfo | 0 . . . 1 | E | | Refers to information on the |
| | | | | PNGW to function as the |
| | | | | gateway, and is designated by |
| | | | | the PNGW or the |
| | | | | CPNS server. |
| | | | | When the PNGW requesting a |
| | | | | delegation does not designate |
| | | | | it, the CPNS server designates |
| | | | | it. |
| PNGWID | 1 | A | String | Refers to a PNGW identifier |
| | | | | (second PNGW in this |
| | | | | specification) to function as |
| | | | | the gateway. |
| Name | 0 . . . 1 | A | String | Refers to a name of the |
| | | | | PNGW to function as |
| | | | | the gateway |
| Update | 1 | A | Integer | Refers to a changed |
| | | | | information (update |
| | | | | information) state of the |
| | | | | terminal requesting a |
| | | | | delegation. |
| | | | | 0: Current, remains in a |
| | | | | personal network |
| | | | | configuration member |
| | | | | as the PNGW after the |
| | | | | delegation of authority |
| | | | | 1: Update, remains in a |
| | | | | personal network |
| | | | | configuration member |
| | | | | as the PNE after the |
| | | | | delegation of authority |
| | | | | 2: Removed, the PNE and the |
| | | | | PNGW withdraw from the |
| | | | | personal network (PN) after |
| | | | | the delegation of authority |

The PN manager 511 can also transmit the gateway switching request message to the device (i.e., the PNE included in the same device of the PNGW) intended to be the target of the gateway switching identified through the above described operations. The PN manager 511 also receives the gateway switching response message from the device intended to be the target of the gateway switching in response to the gateway switching request message. The gateway switching response message may contain state information on the PNGW of the device intended to be the target of the gateway switching. Moreover, the PN manager 511 transmits the gateway switching response message containing a result of the authentication indicating whether the device can function as the gateway to the device having requested the gateway switching.

For example, the gateway switching response message received from the device intended to be the target of the gateway switching may include information represented in Table 6, and the gateway switching response message transmitted to the device requesting the gateway switching may include information represented in Table 7.

TABLE 6

| Element | Cardinality | T | Data Type | Description |
|---|---|---|---|---|
| PNGW | 1 | E | | Its sub attributes are |
| Switching | | | | Status |
| Response | | | | Result |
| Status | | | | Presents a success or fail as |
| | | | | a processing result of the |
| | | | | gateway to receive a |
| | | | | delegation of authority for |
| | | | | an authority delegation |
| | | | | request. When a value of |
| | | | | the response message is |
| | | | | failure, personal network |
| | | | | information below except |
| | | | | for a corresponding element |
| | | | | may not be included. |
| | | | | 1: Success |
| | | | | 2: Fail, reject the delegation |
| | | | | of a role of the GW. |
| | | | | 3: Fail, there is no pre- |
| | | | | registered personal network. |
| | | | | 4: Others |

TABLE 7

| Element | Cardinality | T | Data Type | Description |
|---|---|---|---|---|
| PNGW | 1 | E | | Its sub attributes are |
| Switching | | | | Status |
| Response | | | | Result |
| Status | | | | Presents a success or fail as |
| | | | | a processing result of the |
| | | | | gateway to receive a |
| | | | | delegation of authority for |
| | | | | an authority delegation |
| | | | | request. When a value of |
| | | | | the response message is |
| | | | | failure, personal network |
| | | | | information below except |
| | | | | for a corresponding element |
| | | | | may not be included. |
| | | | | 1: Success |
| | | | | 2: Fail, reject the delegation |
| | | | | of a role of the GW. |
| | | | | 3: Fail, there is no pre- |
| | | | | registered personal network. |
| | | | | 4: Others |
| Result | 1 | A | Integer | Refers to a processing result |
| | | | | of requested matters in the |
| | | | | CPNS server. |
| | | | | 1: Success |
| | | | | 2: Fail, refers to the PN that |
| | | | | has not been registered |
| | | | | before. |
| | | | | 3: Fail, refers to the PNE |
| | | | | that is not a personal |
| | | | | network member. |

According to the request for a service or a content of the PNE transmitted by the PNGW, the service processor 513 obtains device information of the corresponding PNE and personal network information corresponding to the personal network including the corresponding PNE. The service processor 513 identifies whether the service or the content requested by the PNE is a service or a content available by the PNE by using the obtained device information and personal network information, and transmits the service or the content through the PN gateway after changing a type of the service or the content to an available type. The service processor 513 stores service information provided from the service/content providing server in the third memory 530, and prepares a service document with reference to the service information. The service document contains a list of various types of services provided from the service/content providing server, an identifier of each service, information on applications required for executing each service, a brief description of each service, etc.

FIG. 7 is a signal flowchart illustrating a method of managing the connection with the CPNS server according to a first embodiment of the present invention.

In step 701, devices 71, 74, and 77 included in the personal network perform a physical pairing to configure the personal network. In step 702, a role of each device 71, 74, or 77 connected through the pairing within the personal network is identified, and a personal network establishment process for configuring a network between the PNE and the PNGW included in the devices 71, 74, and 77 is performed. Through an authentication and an authorization by the personal network establishment, a determination is performed as to whether the devices 71, 74, and 77 are available for the CPNS, and the network for providing the CPNS in an aspect of an application is configured by performing a series of processes of identifying the role of each device, that is, identifying whether each device operates in a GW mode or a PNE mode. Through the personal network configured as described above, the PNE can access the CPNS server of a service provider network by using a communication function of the PNGW. When the personal network and the CPNS system are configured through the above processes, all CPNS entities within the CPNS system share the same PN inventory value.

The personal network including first, second, and third devices 71, 74, and 77 is configured through step 702. Further, the first device 71 and the second device 74 each include a PNE and a PNGW, while the third device 77 includes only a PNE. A first PNGW 72 included in the first device 71 functions as the gateway, and the second device 74 only functions as a second PNE 76.

In step 703, in order to delegate a gateway function to another device, the first PNGW 72 of the first device 71 having already accessed the CPNS server identifies mode information of the device included in the personal network from the PN inventory stored in an external memory to search PNGWs included in another device within the personal network. The first PNGW 72 selects a PNGW (e.g., second PNGW 75) to be a target of the gateway switching within the personal network from the found PNGWs included in another device.

In step 704, a gateway switching request message for requesting the gateway switching is generated, identification information of a second PNE 76 included in the same second device 74 of the second PNGW 75 is identified, and the gateway switching request message is transmitted to the second PNE 76. At this time, the gateway switching request message may contain all of identification information of the personal network, identification information of the first PNGW 72 included in the first device 71 requesting the gateway switching, identification information of the second PNGW 75 included in the second device 74 intended to be the target of the gateway switching, and expected state information of the first PNGW 72 included in the device 71 requesting the gateway switching (that is, mode information of the device to be set after a gateway function is delegated to another PNGW). This information may be represented according to Table 1 above.

In step 705, the second PNE 76 identifies state information of the second PNGW 75 in response to reception of the gateway switching request message. More specifically, the second PNE 76 identifies whether the second PNGW 75 is activated or deactivated. When the second PNGW 75 is deactivated, the second PNE 76 controls such that second PNGW 75 is activated. Further, when the second PNGW 75 is deactivated, the second PNE 76 further identifies whether the second PNGW 75 is automatically deactivated by a basic setting of the second device 74 (for example, a case where the second PNGW 75 is deactivated because a residual quantity of a battery is equal to or smaller than a predetermined value) or the second PNGW 75 is intentionally deactivated by a user's setting. The second PNE 76 controls the activation/inactivation of the second PNGW 75 in consideration of the above described state and the like. For example, when the second PNGW 75 is deactivated by the basic setting of the second device 74, the second PNE 76 controls such that the second PNGW 75 is activated. When the second PNGW 75 is intentionally deactivated by the user's setting, the second PNE 76 controls maintenance of the inactive state of the second PNGW 75, and notifies the first PNGW 72 included in the first device 71 that the PNGW within the personal network cannot be switched.

In step 706, the second PNE 76 transmits the gateway switching request message to the second PNGW 75. In step 707, a determination is made as to whether the second PNGW 75 performs the gateway function within the personal network. When the second PNGW 75 performs the gateway function within the personal network, the second PNGW 75 generates the PN update request message (see Table 2 herein above), and transmits the generated PN update request message to a CPNS server 78.

In step 708, the CPNS server 78 processes an authorization indicating whether the second PNGW 75, which is the intended target of the gateway switching, can function as the gateway. When the second PNGW 75 is authorized to function as the gateway, the CPNS server 78 switches the gateway of the personal network to the second PNGW 75 in the inventory stored in the CPNS server 78 and updates the inventory.

In step 709, the CPNS server 78 provides the PN update request message (see Table 3 herein above) containing the authorization result indicating whether the second PNGW 75 can function as the gateway to the second PNGW 75.

In step 710, information included in the PN update response message is identified. When the authorization of the second PNGW 75 to function as the gateway is successful, the gateway of the personal network is switched to the second PNGW 75 in the inventory stored in the second PNGW 75, a mode of the first device 71 is reset according to expected state information of the first PNGW 72, and the inventory stored in the second PNGW 75 is updated. The second PNGW 75 provides the gateway switching response message (see Table 4 herein above), which indicates that the gateway of the personal network is switched to the second PNGW 75 to the first PNGW 72.

In step 712, as gateway function is delegated to the second PNGW 76, the first PNGW 72 switches the gateway of the personal network to the second PNGW 75 in the inventory stored in the first PNGW 72, resets the mode of the first device 71 according to the expected state information of the first PNGW 72, and updates the inventory stored in the first PNGW 72.

In step 713, the second PNGW 75 provides a PN update notification message indicating that the gateway of the personal network is switched to the second PNGW 75 to the third device 77.

When the authorization result of the information included in the PN update response message received in step 709 corresponds to the failure, the second PNGW 75 does not switch the gateway of the personal network to the second PNGW 75, and provides the first PNGW 72 with information indicating whether authorization of the second PNGW 75 to function as the gateway corresponds is unsuccessful through the gateway switching response message.

FIG. 8 is a signal flowchart illustrating a method of managing the connection with the CPNS server according to a second embodiment of the present invention.

Referring to FIG. 8, the method of managing the connection with the CPNS server according to the second embodiment of the present invention is similar to the method of managing the connection with the CPNS server according to the first embodiment of the present invention. However, according to the first embodiment of the present invention the method of managing the CPNS server 78 is determined by the second device 74, and both the state information (i.e., information indicating whether the function of the gate may be performed within the personal network) and the authorization result determined by the CPNS server 78 are provided to the first PNGW 72 by the second PNGW 75. By contrast, according to the second embodiment of the present invention the method of managing the connection with the CPNS server 78 is determined by the second device 74, and the state information (i.e., information indicating whether the function of the gate may be performed within the personal network) is provided to the first PNGW 72 by the second PNGW 75, but the authorization result is provided to the first PNGW 72 by the CPNS server 78.

Accordingly, steps 801 to 806 of FIG. 8 according to the second embodiment of the present invention are the same as steps 701 to 706 corresponding to FIG. 7 according to the first embodiment of the present invention.

In step 807, the second PNGW 75 identifies the state information indicating whether the second PNGW 75 functions of the gateway, and provides the gateway switching response message containing the state information to the first PNGW 72. At this time, the gateway switching response message provided to the first PNGW 72 is determined by the second device 74 and may be configured to include only the state information.

When the state information indicates that the second PNGW 75 cannot function as the gateway, the second PNGW 75 does not perform the following steps 808 to 814.

However, when the state information indicates the second PNGW 75 can function as the gateway, the second PNGW 75 generates the PN update request message (see Table 2 herein above) and transmits the generated PN update request message to the CPNS server 78 in step 808.

In step 809, the CPNS server 78 processes the authorization indicating whether the second PNGW 75, which is the target of the gateway switching, can function as the gateway. Further, when the second PNGW 75 is authorized to function as the gateway, the CPNS server 78 switches the gateway of the personal network to the second PNGW 75 in the inventory stored in the CPNS server 78 and updates the inventory.

Next, the CPNS server 78 provides the PN update response message (see Table 3 herein above) containing the authorization result indicating whether the second PNGW 75 can function as the gateway to the second PNGW 75 in step 810, and provides the PN update notification message containing the authorization result to the first PNGW 72 at the same time in step 811.

When the authorization is successful, the gateway of the personal network is switched to the second PNGW 75 in the inventory stored in the first PNGW 72, a mode of the first device 71 is reset according to expected state information of the first PNGW 72, and the inventory stored in the first PNGW 72 is updated in step 812.

Meanwhile, the second PNGW 75 switches the gateway of the personal network to the second PNGW 75 in the inventory stored in the second PNGW 75, resets the mode of the first device 71 according to the expected state information of the first PNGW 72, and updates the inventory stored in the second PNGW 75 in step 813. In step 814, the second PNGW 75 provides the PN update notification message, which indicates that the gateway of the personal network has been switched to the second PNGW 75 to a third device 77.

In contrast, when the authorization fails, steps 812 to 814 are not performed, and the first PNGW 72 and the second PNGW 75 do not switch the gateway of the personal network to the second PNGW 75.

FIG. 9 is a signal flowchart illustrating a method of managing the connection with the CPNS server according to a third embodiment of the present invention.

Referring to FIG. 9, the methods of managing the connection with the CPNS server according to the first and second embodiments of the present invention perform the gateway switching based on the first and second devices 71 and 74 included in the personal network, but the method of managing the connection with the CPNS server according to a third embodiment of the present invention performs the gateway switching based on the CPNS server 78.

Steps 901 and 902 of FIG. 9 according to the third embodiment of the present invention are performed in the same manner as steps 701 and 702 of FIG. 7 according to the first embodiment of the present invention.

In step 903, the first PNGW 72 of the first device 71, which has already accessed the CPNS server 78, generates a gateway switching request message for requesting to switch the gateway to the PNGW included in another device. In step 904, the first PNGW 72 transmits the gateway switching request message to the CPNS server 78. At this time, the gateway switching request message contains identification information of the personal network, identification information of the first PNGW 72 included in the first device 71 requesting the gateway switching, information indicating whether identification information of the PNGW included in the device intended to be the target of the gateway switching is included in the gateway switching request message, identification information of the second PNGW 75 included in the second device intended to be the target of the gateway switching, expected state information of the first PNGW 72 included in the first device 71 requesting the gateway switching (that is, mode information of the device to be set after the gateway function is delegated to another PNGW), etc. The gateway switching request message may include information represented in Table 5 above.

When the identification information of the PNGW included in the device intended to be the target of the gateway switching is included in the gateway switching request message, the CPNS server 78 identifies identification information of the second PNGW 75 included in the second device 74 intended to be the target of the gateway switching and the second PNE 76 included in the second device 74 based on the mode information of the device stored in the inventory in step 905. The CPNS server 78 processes the authorization indicating whether the second device 74 intended to be the target of the gateway switching can function as the gateway.

Meanwhile, when the identification information of the PNGW included in the device intended to be the target of the gateway switching is not included in the gateway switching request message, the CPNS server 78 searches for the device in which the PNGW is activated within the personal network and selects the device including the PNGW to be switched as the gateway based on the mode information of the device stored in the inventory in step 905. In selecting the device including the PNGW to be switched as the gateway, the PN manager 511 processes the authorization indicating whether the device in which the PNGW is activated can function as the gateway to select the device including the PNGW to be switched as the gateway.

In step 906, the CPNS server 78 transmits the gateway switching request message to the second device 74 intended to be the target of the gateway switching. Specifically, the gateway switching request message may be transmitted to the second PNGW 75 of the second device 74.

In response to the gateway switching request message, the second PNGW 75 identifies whether the second PNGW 75 functions as the gateway within the personal network, in step 907. When the second PNGW 75 functions as the gateway within the personal network, the gateway of the personal network is switched to the second PNGW 75 in the inventory stored in the second PNGW 75, a mode of the first device 71 is reset according to expected state information of the first PNGW 72, and the inventory stored in the second PNGW 75 is updated. As shown in Table 6, a gateway switching response message containing the state information indicating whether the second PNGW 75 functions as the gateway within the personal network is transmitted to the CPNS server 78, in step 908.

However, when the second PNGW 75 does not function as the gateway within the personal network, the inventory is not updated, and the gateway switching response message containing the state information indicating whether the second PNGW 75 performs the function of the gateway within the personal network is transmitted to the CPNS server 78.

In step 909, when the second PNGW 75 functions as the gateway within the personal network, the CPNS server 78 switches the gateway of the personal network to the second PNGW 75 in the inventory stored in the CPNS server 78 and updates the inventory in consideration of the state information contained in the gateway switching response message. However, when the second PNGW 75 does not function as the gateway, step 910 is performed without the inventory update in step 909. In step 710, the CPNS server 78 generates the gateway switching response message containing the state information and the authorization result, and provides the gateway switching response message to the first PNGW 72 as shown in FIG. 7. Accordingly, as the function of the gateway is delegated to the second PNGW 75, the first PNGW 72 switches the gateway of the personal network to the second PNGW 75 in the inventory stored in the first PNGW 72, resets the mode of the first device 71 according to the expected state information of the first PNGW 72, and updates the inventory stored in the first PNGW 72 in step 712.

In step 912, the second PNGW 75 provides a PN update notification message indicating that the gateway of the personal network has been switched to the second PNGW 75 to the third device 77.

However, when the state information and the authorization result contained in the gateway switching response message received in step 910 corresponds to a failure, the first PNGW 72 does not perform steps 911 to 912, and does not switch the gateway of the personal network to the second PNGW 75.

Hereinafter, operations of the PNGW included in the device requesting the gateway switching, the PNGW and the PNE included in the device intended to be the target of the gateway switching, and the CPNS server will be described, respectively. The following example describes a method of managing the connection with the CPNS server according to an embodiment of the present invention that is implemented within the CPNS system including the personal network including the first, second, and third devices 71, 74, and 77 and the CPNS server as described with reference to FIGS. 7 to 9. Further, the first device 71 and the second device 74 each include a PNE and a PNGW, and the third device 77 includes only a PNE. The first PNGW 72 included in the first device 71 functions as the gateway in the personal network, and the second device 74 functions as the second PNE 76. Accordingly, the device requesting the gateway switching is the first device 71, and the device that is the target of the gateway switching is the second device 74.

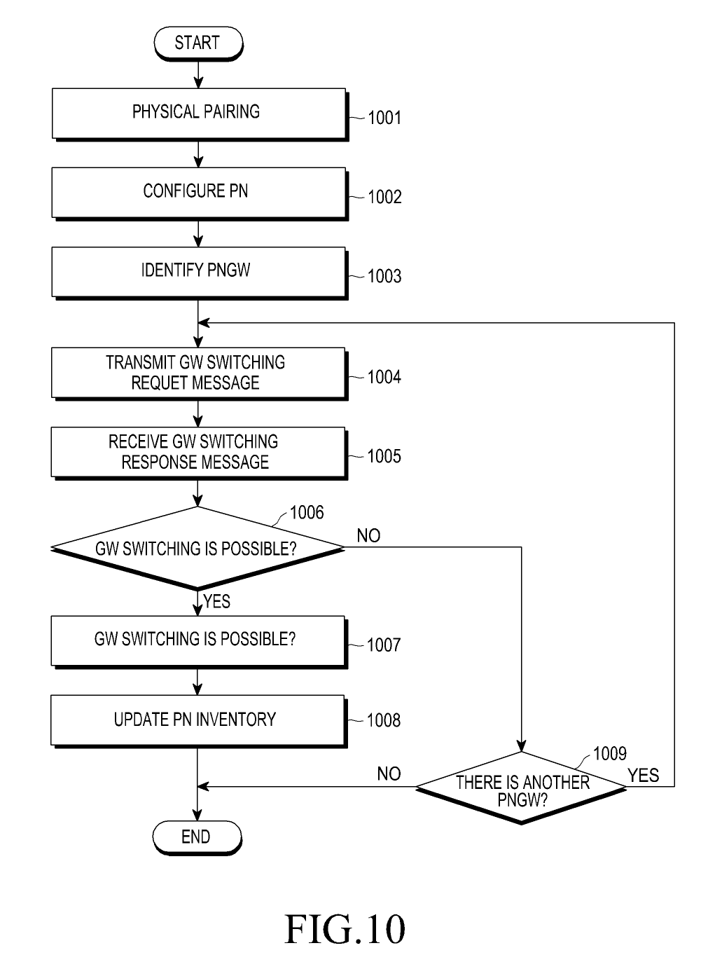

FIG. 10 is a flowchart illustrating operations of the PNGW included in the device making a request for the gateway switching according to an embodiment of the present invention.

Referring to FIG. 10, in step 1001, the devices 71, 74, and 77 included in the personal network perform a physical pairing to configure the personal network. In step 1002, a role of each device 71, 74, and 77 connected through the pairing within the personal network is identified, and a personal network establishment process for configuring a network between the PNE and the PNGW included in the devices 71, 74, and 77 is performed. Through an authentication and an authorization by the personal network establishment, a determination is performed as to whether each of the devices 71, 74, and 77 is available for the CPNS, and the network for providing the CPNS in an aspect of an application is configured by performing a series of processes of identifying the role of each device, that identifies whether each device operates in a GW mode or a PNE mode. Through the personal network configured as described above, the PNE can access the CPNS server of a service provider network by using a communication function of the PNGW. Further, when the personal network and the CPNS system are configured through the above processes, all CPNS entities within the CPNS system share the same PN inventory value.

In step 1003, in order to delegate the functions of the gateway to another device, the second PNGW 72 identifies mode information of the device included in the personal network from a PN inventory stored in an external memory, and searches for PNGWs included in another device within the personal network. Further, the first PNGW 72 selects a PNGW (for example, second PNGW 75) that becomes a target to be switched to the gateway within the personal network from the found PNGWs included in the another device.

In step 1004, the first PNGW 72 generates a gateway switching request message for requesting the gateway switching, identifies identification information of the second PNE 76 included in the same second device 74 of the selected second PNGW 75, and transmits the gateway switching request message to the second PNE 76. At this time, the gateway switching request message may contain identification information of the personal network, identification information of the first PNGW 72 included in the first device 71 requesting the gateway switching, identification information of the second PNGW 75 included in the second device 74 which becomes the target of the gateway switching, and expected state information of the first PNGW 72 included in the device 71 requesting the gateway switching (i.e., mode information of the device to be set after a gateway function is delegated to another PNGW), and may include information represented in Table 1 above.

Further, in the methods of managing the connection with the CPNS server according to the first and second embodiments of the present invention described with reference to FIGS. 7 and 8, the PNGW (for example, second PNGW 75) that becomes the target to be switched to the gateway within the personal network is selected, and then inserted in the gateway switching request message as described above with reference to steps 1003 and 1004 of FIG. 10. However, in the method of managing the connection with the CPNS server according to the third embodiment of the present invention, as described with reference to FIG. 3, the gateway switching request message may contain information indicating whether the identification information of the PNGW included in the device intended to be the target of the gateway switching is included in the message. Accordingly, steps 1003 and 1004 described above may be configured as follows. Mores specifically step 1003 is not performed, and the gateway switching request message containing the identification information of the personal network, the identification information of the first PNGW 72 included in the first device 71 requesting the gateway switching, information indicating whether the identification information of the PNGW included in the device intended to be the target of the gateway switching is included, the expected state information of the first PNGW 72 included in the first device 71 requesting the gateway switching (that is, mode information of the device to be set after a gateway function is delegated to another PNGW), etc., is generated and may be transmitted to the CPNS server 78 in step 1004.

Meanwhile, in step 1005, the first PNGW 71 receives a gateway switching response message. The first PNGW 71 identifies information contained in the gateway switching response message, and identifies whether the gateway may be switched to the second PNGW 75. Information indicating whether the gateway is switched to the second PNGW 75 may be determined by identifying state information generated by the second device 74 or an authorization result generated by the CPNS server 78.

In the methods of managing the connection with the CPNS server according to the first and third embodiments of the present invention described with reference to FIGS. 7 and 9, the gateway switching response message provided by the second PNGW 75 contains all of the state information generated by the second device 74 or the authorization result generated by the CPNS server 78. According to the methods of managing the connection with the CPNS server according to the first and third embodiments of the present invention, the first PNGW 72 identifies the state information and the authorization result to identify whether the gateway is switched in step 1005.

By contrast, in the method of managing the connection with the CPNS server according to the second embodiment of the present invention described with reference to FIG. 8, the first PNGW 72 can receive the state information through the gateway switching response message provided by the second PNGW 75, and receive the authorization result through the PN update notification message from the CPNS server 78. Therefore, according to the method of managing the connection with the CPNS server according to the second embodiment of the present invention, the first PNGW 72 identifies the state information and the authorization result from the gateway switching response message and the PN update notification message, respectively, to identify whether the gateway is switched in step 1005.

Meanwhile, when the gateway can be switched to the second PNGW 75 in step 1006, step 1007 is performed. However, when the gateway cannot be switched to the second PNGW 75, step 1009 is performed.

In step 1007, as the function of the gateway is delegated to the second PNGW 75, the first PNGW 72 switches the gateway of the personal network to the second PNGW 75 in the inventory stored in the first PNGW 72 and resets a mode of the first device 71 according to the expected state information of the first PNGW 72. Further, the first PNGW 72 updates the inventory stored in the first PNGW 72 in step 1008.

Meanwhile, in step 1009, the first PNGW 72 searches the inventory stored in the first PNGW 72 again to identify whether there is another PNGW other than the second PNGW 75. When there is another PNGW other than the second PNGW 75, steps 1004 to 1008 described above are performed again. When there are no other PNGWs other than the second PNGW 75, the gateway switching operation is terminated.

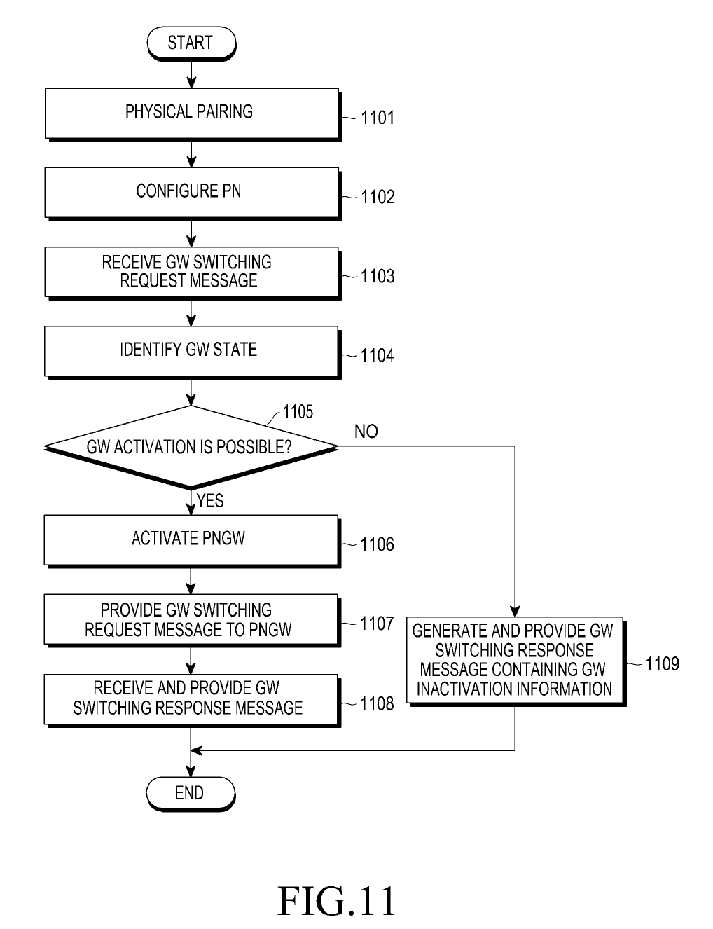

FIG. 11 is a flowchart illustrating operations of the PNE included in the device intended to be the target of the gateway switching in a method of managing the connection with the CPNS server according to an embodiment of the present invention.

Referring to FIG. 11, in a manner similar to that of steps 1001 and 1002 as described above with reference to FIG. 10, in step 1101 of FIG. 11, the devices 71, 74, and 77 included in the personal network perform the physical pairing to configure the personal network. In step 1102, a role of each device 71, 74, and 77 connected through the pairing within the personal network is identified, and a personal network establishment process for configuring a network between the PNE and the PNGW included in the devices 71, 74, and 77 is performed. Through an authentication and an authorization by the personal network establishment, a determination is performed as to whether the devices are devices available for the CPNS, and the network for providing the CPNS in an aspect of an application is configured by performing a series of processes of identifying the role of each device, and identifying whether each device operates in a GW mode or a PNE mode. Through the personal network configured as described above, the PNE can access the CPNS server of a service provider network by using a communication function of the PNGW. When the personal network and the CPNS system are configured through the above processes, all CPNS entities within the CPNS system share the same PN inventory value.

In step 1103, the second PNE 76 receives the gateway switching request message for requesting the gateway switching from the first PNGW 72. At this time, the gateway switching request message may contain identification information of the personal network, identification information of the first PNGW 72 included in the first device 71 requesting the gateway switching, identification information of the second PNGW 75 included in the second device 74 intended to be the target of the gateway switching, and expected state information of the first PNGW 72 included in the first device 71 requesting the gateway switching (that is, mode information of the device to be set after a gateway function is delegated to another PNGW), and may include information represented in Table 1 above.

In step 1104, the second PNE 76 identifies a state of the second PNGW 75. Specifically, the second PNE 76 identifies whether the second PNGW 75 is activated or deactivated. When the second PNGW 75 is deactivated, a determination is performed as to whether the second PNGW 75 can be activated in step 1105. When the second PNGW 75 is automatically deactivated by a basic setting of the second device 74 (e.g., when the second PNGW 75 is deactivated due to a remaining battery level is less than or equal to a predetermined value), it is determined that the second PNGW 75 cannot be activated. When the second PNGW 75 is intentionally deactivated by the user's setting, it is determined that the second PNGW 75 cannot be activated. When the second PNGW 75 can be activated, step 1106 is performed. When the second PNGW 75 cannot be activated, step 1109 is performed.

When the second PNGW 75 is deactivated, the second PNE 76 controls activation of the second PNGW 75 in step 1106. Further, the second PNE 76 transmits the gateway switching request message to the second PNGW 75 in step 1107.

In step 1108, the second PNE 76 receives the gateway switching response message from the second PNGW 75, and provides the received gateway switching response message to the first PNGW 72.

Meanwhile, in step 1109, the second PNE 76 maintains the inactive state of the second PNGW 75, and notifies the first PNGW 72 included in the first device 71 that the PNGW within the personal network cannot be switched.

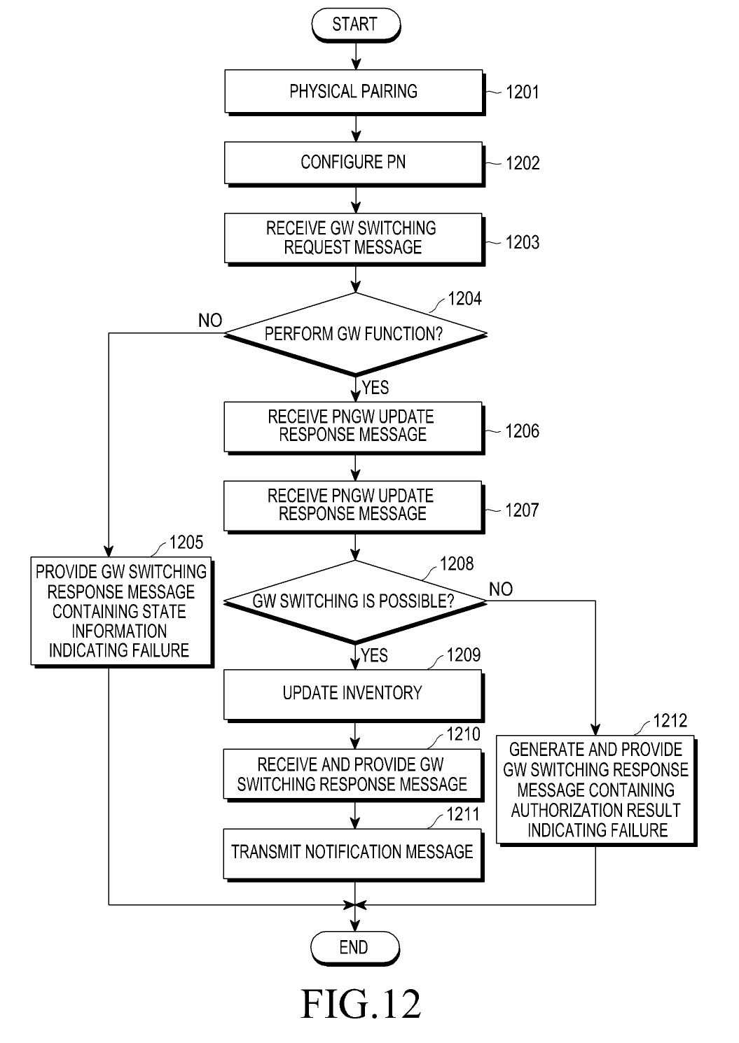

FIG. 12 is a flowchart illustrating operations of the PNGW included in the device intended to be the target of gateway switching in a method of managing the connection with the CPNS server according to an embodiment of the present invention.

Referring to FIG. 12, step 1201 is performed in a manner similar to that of steps 1001 and 1002 described herein above with reference to FIG. 10, where the devices 71, 74, and 77 included in the personal network perform the physical pairing to configure the personal network. In step 1202, a role of each device 71, 74, and 77 connected through the pairing within the personal network is identified, and a personal network establishment process for configuring a network between the PNE and the PNGW included in the devices 71, 74, and 77 is performed. Through an authentication and an authorization by the personal network establishment, a determination is performer as to whether the devices are devices available for the CPNS, and the network for providing the CPNS in an aspect of an application is configured by performing a series of processes of identifying the role of each device, and identifying whether each device operates in a GW mode or a PNE mode. Through the personal network configured as described above, the PNE can access the CPNS server of a service provider network by using a communication function of the PNGW. Further, when the personal network and the CPNS system are configured through the above processes, all CPNS entities within the CPNS system share the same PN inventory value.

The second PNGW 75 receives the gateway switching request message from the second PNE 76 in step 1203. The second PNGW 75 identifies whether the second PNGW 75 performs the function of the gateway within the personal network. When the second PNGW 75 performs the function of the gateway within the personal network, step 1206 is performed, and thus the PN update request message (see Table 2 above) is generated and transmitted to the CPNS server 78. However, when the second PNGW 75 does not perform the function of the gateway within the personal network, step 1205 is performed.

The second PNGW 75 transmits a gateway switching response message indicating that the second PNGW 75 does not perform the function of the gateway within the personal network to the first PNGW 72 in step 1205.

In step 1207, the second PNGW 75 receives the PN update response message from the CPNS server 78, identifies information contained in the PN update response message, and identifies an authorization result indicating whether the second PNGW 75 can function as the gateway. When the authorization is successful, step 1209 is performed. However, when the authorization fails, step 1012 is performed.

In step 1209, the second PNGW 75 switches the gateway of the personal network to the second PNGW 75 in the inventory stored in the second PNGW 75, resets the mode of the first device 71 according to the expected state information of the first PNGW 72, and updates the inventory stored in the second PNGW 75. The second PNGW 75 provides the gateway switching response message (see Table 4 above) containing information indicating that the gateway of the personal network is switched to the second PNGW 75 to the first PNGW 72 through step 1210.

In step 1211, the second PNGW 75 provides the PN update notification message, which indicates that the gateway of the personal network is switched to the second PNGW 75, to the third device 77.

Meanwhile, in step 1212, the gateway switching response message, which contains the authorization failure result, is provided to the first PNGW 72.

In the method of managing the connection with the CPNS server according to the first embodiment of the present invention, the gateway switching response message can be provided to the first PNGW 72 after the PN update request message/PN update response message is exchanged with the CPNS server 78, such as in steps 1210 and 1211 described above. However, in the method of managing the connection with the CPNS server according to the second embodiment of the present invention, the gateway switching response message is transmitted before the PN update request message/PN update response message is exchanged with the CPNS server 78, and the authorization result provided by the CPNS server 78 are directly provided to the first PNGW 72 by the CPNS server 78, instead of by the second PNGW 75. Accordingly, step 1210 described above may be performed between steps 1204 and 1206, and step 1212 may be performed separately.

In methods of managing the connection with the CPNS server according to the first and second embodiments of the present invention described through FIGS. 7 and 8, the CPNS server 78 receives the PN update request message from the second PNGW 75, processes the authorization indicating whether the PNGW intended to be the target of the gateway switching can function as the gateway, updates the inventory of the personal network according to an authorization result, and provides the PN update response message containing the authorization result to the second PNGW 75. As a result, the methods of managing the connection with the CPNS server according to the first and second embodiments of the present invention implement the gateway switching based on the first and second devices 71 and 74 included in the personal network (i.e., perform the above-described operations).

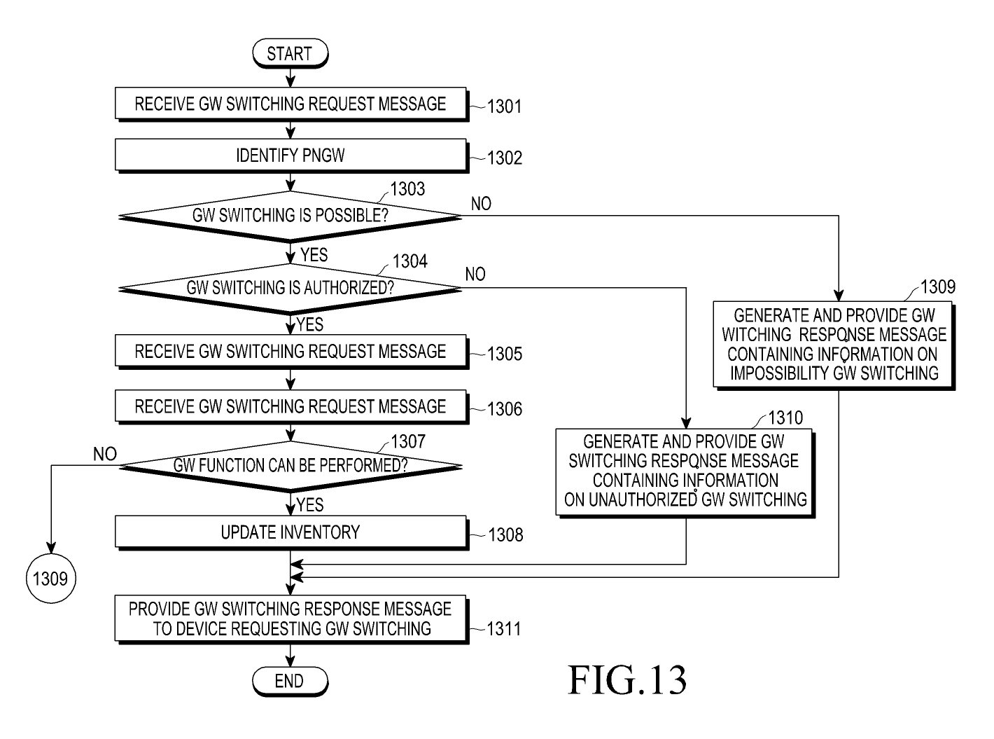

By contrast, the method of managing the connection with the CPNS server according to the third embodiment of the present invention described with reference to FIG. 9 implements the gateway switching based on the CPNS server 78. Accordingly, FIG. 13 below describes the operation of the CPNS server for implementing the method of managing the connection with the CPNS server according to the third embodiment of the present invention.

FIG. 13 is a flowchart illustrating operations of the CPNS server in a method of managing a connection with a CPNS server according to an embodiment of the present invention.

Referring to FIG. 13, in step 1301, the CPNS server 78 receives a gateway switching request message from the first PNGW 72. At this time, the gateway switching request message contains identification information of the personal network, identification information of the first PNGW 72 included in the first device 71 requesting the gateway switching, information indicating whether identification information of the PNGW included in the device intended to be the target of the gateway switching is included, identification information of the second PNGW 75 included in the second device intended to be the target of the gateway switching, expected state information of the first PNGW 72 included in the first device 71 requesting the gateway switching (i.e., mode information of the device to be set after the gateway function is delegated to another PNGW), etc. The gateway switching request message may include information represented in Table 5 above.

In step 1302, the CPNS server 78 identifies the second PNGW 75 included in the second device 74 intended to be the target of the gateway switching. Specifically, when the gateway switching request message contains the identification information of the PNGW included in the device intended to be the target of the gateway switching, the CPNS server 78 identifies identification information of the second PNGW 75 included in the second device 74 intended to be the target of the gateway switching and the second PNE 76 included in the second device 74 based on mode information of the device stored in the inventory.

Meanwhile, when the gateway switching request message does not contain the identification information of the PNGW included in the device intended to be the target of the gateway switching, the CPNS server 78 searches for the device in which the PNGW is activated in the personal network and selects the device including the PNGW to be switched as the gateway based on mode information of the device stored in the inventory. In selecting the device including the PNGW to be switched as the gateway, the CPNS server 78 processes the authorization indicating whether the device in which the PNGW is activated can function as the gateway to select the device including the PNGW to be switched as the gateway.

Next, in step 1303, the CPNS server 78 identifies whether the second PNGW 75 included in the selected second device 74 can operate as the gateway based on the mode information of the device stored in the inventory. When the second PNGW 75 included in the second device 74 can operate as the gateway, step 1304 is performed. When the second PNGW 75 included in the second device 74 cannot operate as the gateway, step 1309 is performed.

Next, in step 1304, the CPNS server 78 processes the authorization indicating whether the second device 74 to be target of the gateway switching can function as the gateway. When the authorization corresponds to the success, step 1305 is performed. When the authorization corresponds to the failure, step 1310 is performed.

In step 1305, the CPNS server 78 transmits the gateway switching request message to the second device 74 intended to be the target of the gateway switching. Specifically, the gateway switching request message may be transmitted to the second PNGW 75 of the second device 74.

In response to the gateway switching request message, the CPNS server 78 receives a gateway switching response message indicating whether the second PNGW 75 performs the function as the gateway within the personal network from the second PNGW 75 in step 1305.

In response to the state information contained in the gateway switching response message, the CPNS server 78 proceeds to step 1308 when the second PNGW 75 performs the function of the gateway within the personal network in step 1307, and the CPNS server 78 proceeds to step 1309 when the second PNGW 75 does not perform the function of the gateway within the personal network.

In step 1308, the CPNS server 78 switches the gateway within the personal network to the second PNGW 75 in the inventory stored in the CPNS server 78, and updates the inventory.

Meanwhile, in step 1309, the CPNS server 78 generates the gateway switching response message containing information indicating that the state information corresponds to the failure. Further, in step 1310, the CPNS server 78 generates the gateway switching response message containing information indicating that the authorization result corresponds to the failure.

Next, in step 1311, the CPNS server 78 generates the gateway switching response message containing the state information and the authorization result, and provides the gateway switching response message to the first PNGW 72.

According to the above described embodiments of the present invention, it is possible to stably switch the gateway accessing the CPNS server while maintaining the already configured personal network in the CPNS system.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A method of managing a connection between a Personal Network (PN) and a Converged Personal Network Service (CPNS) server by a first device in a CPNS system including the personal network configured between the first device and a second device including at least one of a Personal Network Entity (PNE) and a Personal Network GateWay (PNGW) and the CPNS server connected with the personal network through a first communication network, the method comprising:
identifying the second device including the PNGW by using device mode information indicating whether the second device included in a PN inventory includes the PNE and the PNGW;
requesting a connection between the CPNS server and the second device through the first communication network; and
terminating the connection to the CPNS server connected through the first communication network according to the connection between the CPNS server and the second device through the first communication network.

2. The method as claimed in claim 1, wherein identifying the second device comprises determining a device including the PNGW as the second device based on the device mode information.

3. The method as claimed in claim 1, wherein requesting the connection between the CPNS server and the second device comprises identifying an operation state of the PNGW included in the second device, and transmitting a gateway switching request message to the PNE of the second device for controlling an operation of the PNGW.

4. The method as claimed in claim 3, wherein the gateway switching request message contains identification information that indicates the personal network including the first device, identification information of the PNGW included in the first device, identification information of the PNGW included in the second device, and expected state information of the PNGW included in the first device.

5. The method as claimed in claim 1, wherein requesting the connection between the CPNS server and the second device comprises transmitting a gateway switching request message for requesting the connection between the CPNS server and the second device to the CPNS server.

6. The method as claimed in claim 5, wherein the gateway switching request message contains identification information that indicates the personal network including the first device, identification information of the PNGW included in the first device, information indicating whether identification information of the PNGW included in the second device is included, the identification information of the PNGW included in the second device, and expected state information of the PNGW included in the first device.

7. The method as claimed in claim 1, wherein terminating the connection to the CPNS server comprises:
receiving a gateway switching response message indicating a processing result of a gateway switching; and
renewing the PN inventory stored in the PNGW according to the processing result indicated by the gateway switching response message.

8. The method as claimed in claim 7, wherein the gateway switching response message contains information indicating whether the gateway switching is acceptable from at least one of the second device and the CPNS server.

9. The method as claimed in claim 8, wherein terminating the connection to the CPNS server further comprises receiving, from the CPNS server, a notification message indicating whether the gateway switching by the CPNS server is accepted by the CPNS server.

10. The method as claimed in claim 8, wherein the gateway switching response message indicates whether the gateway switching by the second device is accepted by the CPNS server and information indicating whether the gateway switching by the CPNS server is accepted by the CPNS server.

11. A method of managing a connection between a personal network and a Converged Personal Network Service (CPNS) server by a second device in a CPNS system including the personal network configured between a first device and the second device including at least one of a Personal Network Entity (PNE) and a Personal Network GateWay (PNGW) and the CPNS server connected with the personal network through a first communication network, the method comprising:
receiving a request to connect to the CPNS server, which is issued from the first device connected to the CPNS server through the first communication network, through the first communication network, by the second device including the PNGW;
identifying whether the connection to the CPNS server through the first communication network is available;
providing the first device with information indicating whether the connection to the CPNS server through the first communication network is available; and
notifying a third device that the second device has connected to the CPNS server through the first communication network according to an availability of the connection to the CPNS server through the first communication network.

12. The method as claimed in claim 11, wherein receiving the request to connect to the CPNS server comprises receiving a gateway switching request message from the first device by the PNE of the second device, and
wherein the gateway switching request message contains identification information that indicates the personal network including the first device, identification information of the PNGW included in the first device, identification information of the PNGW included in the second device, and expected state information of the PNGW included in the first device.

13. The method as claimed in claim 12, wherein identifying whether the connection to the CPNS server through the first communication network is available comprises:
identifying an operation state of the PNGW included in the second device by the PNE of the second device; and
providing the PNGW with the gateway switching request message according to an active state of the operation state of the PNGW, by the PNE of the second device.

14. The method as claimed in claim 13, wherein identifying whether the connection to the CPNS server through the first communication network is available comprises:
transmitting a PN update request message containing the identification information that indicates the personal network including the first device, the identification information of the PNGW included in the first device, the identification information of the PNGW included in the second device, the expected state information of the PNGW included in the first device, and information of requesting an authorization for the connection to the CPNS server by the PNGW included in the second device to the CPNS server, by the PNGW; and
receiving, from the CPNS server, a PN update response message containing information indicating whether the connection to the CPNS server by the PNGW included in the second device is authorized.

15. The method as claimed in claim 14, wherein providing the first device with the information indicating whether the connection to the CPNS server through the first communication network is available comprises providing the first device with a gateway switching response message containing information indicating the operation state of the PNGW included in the second device and indicating whether the connection to the CPNS server by the PNGW included in the second device is authorized.

16. The method as claimed in claim 15, wherein providing the first device with the information indicating whether the connection to the CPNS server through the first communication network is available further comprises renewing a PN inventory stored in the PNGW with reflection of the information indicating the operation state of the PNGW included in the second device and whether the connection to the CPNS server by the PNGW included in the second device is authorized.

17. A method of managing a connection between a personal network and a Converged Personal Network Service (CPNS) server by the CPNS server in a CPNS system including the personal network configured between a first device and a second device including at least one of a Personal Network Entity (PNE) and a Personal Network GateWay (PNGW) and the CPNS server connected with the personal network through a first communication network, the method comprising:
receiving a request for switching the connection through the first communication network from the first device connected through the first communication network to the second device including the PNGW;
identifying whether the second device is available to be connected through the first communication network;
requesting, by the second device, a connection through the first communication network; and
providing the first device connected through the first communication network with information indicating an availability of a connection of the second device through the first communication network according to the identified availability of the second device.

18. The method as claimed in claim 17, wherein identifying the availability of the second device comprises identifying identification information of the PNGW of the second device contained in at least one of the gateway switching request message and the PN inventory stored in the CPNS server, and identifying a connection of the PNGW of the second device through the first communication network.

19. The method as claimed in claim 17, wherein requesting the connection through the first communication network by the second device comprises:
transmitting a gateway switching request message containing identification information that indicates the personal network including the first device, identification information of the PNGW included in the first device, identification information of the PNGW included in the second device, and expected state information of the PNGW included in the first device to the PNGW included in the second device; and
receiving, from the second device, a gateway switching response message whether a gateway switching by the second device is accepted by the second device.

20. The method as claimed in claim 17, wherein providing the first device with the information indicating the availability of the second device comprises renewing a PN inventory stored in the PNGW according to information indicating whether a gateway switching by the second device is accepted and information indicating whether the connection of the PNGW included in the second device through the first communication network is accepted.
